(19) United States
(12) Patent Application Publication
(10) Pub. No.: US 2017/0138407 A1
(43) Pub. Date: May 18, 2017

(54) SLIDING BALL JOINT HAVING CROSSING RACEWAYS HAVING A DIFFERENT ANGLE OF INCLINATION AND A MINIMUM RADIAL DISTANCE

(71) Applicant: NEAPCO EUROPE GMBH, Düren (DE)

(72) Inventors: Peter LOHMBERG, Koln (DE); Mateusz WOJCIECHOWSKI, Aachen (DE); Luis HOEKS, Eschweiler (DE); Michael ELING, Koln (DE); Subramanyam MUNTIMADUGU, Duren (DE)

(21) Appl. No.: 15/322,154

(22) PCT Filed: Mar. 30, 2015
(86) PCT No.: PCT/EP2015/056897

§ 371 Date: Dec. 26, 2016

(30) Foreign Application Priority Data
Jun. 26, 2014 (DE) 10 2014 212 366.6

(51) Int. Cl. F16D 3/229

(52) U.S. Cl. CPC F16D 3/229; F16D 2003/22309

(57) ABSTRACT

A sliding ball joint comprising a joint outer part having inclined ball raceways which are formed on an inner periphery and which are arranged about an axis of rotation of the joint outer part, a joint inner part having inclined ball raceways, which are formed on an outer periphery and which are arranged about an axis of rotation of the joint inner part. Ball raceways of the joint outer part and of the joint inner part face each other in pairs and have angles of inclination opposite to each other, one ball per ball raceway pair, and a cage, which is arranged between the joint outer part and the joint inner part and having windows, in which the balls are accommodated. The joint outer part and the joint inner part each have at least two groups of inclined ball raceways, the groups being different with respect to the magnitude of the angle of inclination to the respective axis of rotation, wherein a first group of ball raceways include an angle of inclination α (alpha) with the respective axis of rotation, and a second group of ball raceways include an angle of inclination β (beta) with the respective axis of rotation, wherein α<β (alpha less than beta) applies to the magnitudes. The ball raceways of the first group have an identical first, minimum radial distance from the respective axis of rotation and the ball raceways of the second group have an identical second, minimum radial distance from the respective axis of rotation, and the first radial distance and second radial distance differ.

### CROSS-REFERENCE TO RELATED APPLICATIONS

This application is a 371 National Stage application of international Application No. PCT/EP2015/056897 filed on Mar. 30, 2015, which claims priority of German (DE) application Serial Number 10 2014 212 366.6 filed on Jun. 26, 2014, all of which are incorporated herein by reference in their entireties.

### BACKGROUND OF THE INVENTION

Field of the Invention

The present invention relates to a sliding ball joint having a joint outer part and a joint inner part, wherein the ball raceways of the joint outer part and the joint inner part face each other in pairs and each having opposite angles of inclination (cross groove, or briefly CG), If respective ball raceways having different angles of inclination alternate, a sliding ball joint will be obtained having alternatingly crossing raceways (briefly aCG).

Description of the Prior Art

Constant velocity joints of the CG type (cross groove) have previously been known. The raceways extend at an angle with respect to the axis of rotation. Two neighboring raceways have a theoretical point of interception. Modern vehicles are characterized, among others, by low noise levels in the interior and low vibrations during traveling. Uneven roads as well as vibrations induced by the drive train are reduced to a minimum level. This, on the one hand, is accomplished, by decoupling, damping, and the use of vibrationally optimized systems matched to each other. On the other hand, any one assembly itself is intended to create minimal commotion. Due to their properties, the joints used in the drive shafts may substantially contribute to excitation of the undesired vibrations of the vehicles.

One embodiment comprising neighboring raceway angles differently configured is known from U.S. Pat. No. 8,070,611 B2 and U.S. Pat. No. 7,347,786 B2. In this “cross straight” constant velocity joints, one raceway extends forming a theoretical point of intersection with the axis of rotation or extends in parallel to said axis of rotation. Thus, the course thereof is in a plane shared with the respective axis of rotation.

### SUMMARY OF THE PRESENT INVENTION

In view of the foregoing, the object of the present invention is to provide a sliding ball joint, which, during operating, generates small sliding forces and/or simultaneously is very efficient and/or is characterized by strong running smoothness.

This object will be solved by way of a sliding bail joint having the features of Claim 1. Other advantages and features of the invention will become apparent from the subclaims. It is to be noted that features individually set forth in the claims may be combined with each other in any technologically expedient way, thereby showing further embodiments of the invention. The description additionally characterizes and specifies the invention especially in combination with the figures.

A sliding ball joint according to the invention comprises a joint outer part having an inner periphery and inclined ball raceways, which are formed on the inner periphery of the joint outer part. The ball raceways are arranged about an axis of rotation of the joint outer part. The inner periphery essentially defines the section perpendicular to the axis of rotation across an inner surface of the joint outer part. For example, the joint outer part comprises a thick walled hollow body and the ball raceways are formed as groove-shaped grooves on its inner surface in the direction of the longitudinal axis of the hollow body, The inner periphery in the sense of the invention then relates to the inner periphery of the hollow body, without considering the grooves,

According to the invention, the sliding hail joint furthermore comprises a joint inner part having an outer periphery and having inclined, especially groove-shaped ball raceways, which are formed on the outer periphery of the joint outer part. The ball raceways are arranged about an axis of rotation of the joint outer part. The outer periphery essentially defines the section perpendicular to the axis of rotation across an outer surface of the joint outer part. For example, the joint inner part comprises a thick-walled hollow body, and the ball raceways are formed as the grooves in the outer surface of the hollow body. The outer periphery, in the sense of the invention, then refers to the outer periphery of the hollow body, without considering the grooves.

With inclined ball raceways, in the sense of the invention, it is meant that in a perpendicular projection of the ball raceways onto a plane, in which the axis of rotation is situated, this projection of the ball raceways intersects the axis of rotation at an angle. Herein in the following, the angle, at which the projection of the ball raceways intersects the axis of rotation, will be referred to as an “angle of inclination”. Wherein, with the raceway according to the invention, the angle of inclination is defined by way of a line that connects both terminal points of the ball raceways. The angle, at which the perpendicular projection of this line intersects the axis of rotation in a plane comprising the axis of rotation is therefore considered as an angle of inclination. The ball raceways thus are distorted out of a position axial-parallel to the axis of rotation.

Both the ball raceways of the joint outer part and the ball raceways of the joint outer part face each other in pairs, and each having opposite angles of inclination. With the inclined ball raceways, increased running smoothness and higher wear resistance of the ball sliding joint is caused. Each ball raceway pair formed in this way, according to the invention, comprises an associated ball. Preferably, the number of the balls, and accordingly, the number of the ball raceway pairs is at least three, and is especially preferred an even number of balls, preferably 6 or 8 balls. Furthermore, the sliding ball joint comprises a cage, which is arranged between the joint outer part and the joint inner part. The cage has windows, which serve to accommodate the balls.

According to the invention, the joint outer part and the joint inner part each comprises at least two groups of inclined ball raceways different in the magnitude of the angle of inclination with respect to the respective axis of rotation. The first group of ball raceways includes an angle of inclination α with the respective axis of rotation and a second group of ball raceways includes an angle of inclination β with the respective axis of rotation, such that the ball raceways of both groups of ball raceways cross each other. The ball raceways of one group are arranged parallel to each other. The course of the ball raceways results from the construction line, describing the vertices, i.e. the deepest points of the ball raceways with respect to the respective joint part, and consequently determine the motion of the respective ball rolling in the ball raceways.

For the magnitudes of the angles of inclination of the ball raceways of the joint outer part and of the joint inner part, according to the invention, it is true that the angle of inclination α of the first group is less in the magnitude than the magnitude of the angle of inclination β of the second group. Preferably, for the magnitudes the following is true: 1>α/ε>0.075. More preferably, the magnitudes are 1>α/β>0.1.

According to the invention, it is provided that the minimum radial distance r_{α} of the ball raceways of the first group having the angle of inclination u differs from the minimum radial distance r_{β} of the ball raceways of the second group having the angle of inclination β. The term minimum radial distance is to be understood such that the respective minimum distance resulting from the course of the ball raceways between the concerned axis of rotation is the crucial. For example a minimum radial distance results if the respective ball raceways of a group, or the construction lines thereof, respectively, are not arranged situated on a cylinder surface surrounding the respective axis of rotation, but merely forming a boundary point with a cylinder surface defined by the minimum radial distance, because each of them is situated for example in a plane tangential to the above-mentioned cylinder, or, in other words, the axis of rotation is parallel to a plane in which the respective hall raceways are situated.

However, it is preferably provided that the respective ball raceways, at least of one group or all groups, i.e. the construction lines thereof, each are arranged in a tangential plane of a cylinder surface to be situated with minimum radial distance about the axis of rotation. Preferably, the ball raceways of the respective group are defined as tangents parallel to each other, to a common cylinder surface surrounding the respective axis of rotation in minimum radial distance. For clarification, it is to be exemplified that, at the respective minimum radial distances r_{α}, r_{β} of the ball raceways, it is allowed the shell surface of a circular cylinder to be designed from the ball raceways of a group. The radius of the bases of the cylinders then corresponds to the respective radial distance r_{α} or r_{β} of the associated ball raceways, respectively. This especially means that the radius r_{α} of the base of the first circular cylinder is greater than the radius r_{β} of the base of the second circular cylinder.

By way of this radial jump it becomes possible, to more effectively utilize the joint volume. Moreover, due to the radial jump, a torque transmission differing per group results, which may advantageously be utilized in designing the raceways.

According to a preferred. embodiment, it is provided that the occasionally minimal first radial distance r_{α} of the first group is greater than the occasionally minimal second radial distance r_{β} of the second group, r_{α}>r_{β} is true, wherein for the magnitudes of the angles of inclination the following is true: α<β. The commotion of a ball sliding joint is essentially influenced by the torque of the balls. The sliding joint will collectively become more resistant.

Preferably, the number of the ball raceways of the first group is equal to the number of the ball raceways of the second group.

Preferably, the ball raceways are arranged such that neighboring ball raceways cross in a theoretical, i.e. imaginary, point. Neighboring ball raceways, in the sense of the invention, refers to ball raceways, which are adjacent in the circumferential direction of the joint inner part or the joint outer part, respectively. This means that neighboring ball raceways are distorted by different angles relative to their axial-parallel position. For example, neighboring ball raceways are distorted by different angles in the clockwise direction relative to their axial-parallel position. According to an advantageous embodiment, the algebraic sign of the angle of inclination changes in the circumferential direction from ball raceways to ball raceways. Preferably, the angles of inclination α of a first group and β of a second group have different algebraic signs, and the ball raceways of the and second group are alternating in the circumferential direction.

According to a preferred embodiment, the magnitude of the difference of the most minimum radial distance of the first group and the most minimum radial distance of the second group is between 0.01 mm and 10.00 mm, and is preferably between 0.10 mm and 1.00 mm.

Preferably, the angle of inclination β (beta) is selected such that it at least equals half an angle of flexion, by which the joint outer part is jointly pivotable. Wherein the angle of flexion, in the sense of the invention, corresponds to the angling of the joint outer part out of the straight or coaxial position.

According to a further embodiment of the ball sliding joint, the ball raceways of at least one group have a linear course, According to a preferred. embodiment, exclusively the ball raceways of the second group have a linear course.

According to a further embodiment, the ball raceways of at least one group have a curved course having a first order inflection point. For example an S-shaped course of the ball raceways of one group results. Preferably, exclusively the ball raceways of the first group are curved, but are formed congruently among each other. In the curved course of the ball raceway, the angle of inclination is defined by an imaginary connecting line between the outer terminal points of the hall raceway.

According to a preferred embodiment, the curved course is point-symmetric to the first order inflection point.

Preferably, the curved course is defined section-wise, preferably across at least a quarter, more preferably across at least one third of its overall course by a constant curvature radius. More preferably, the ratio of the first angle of inclination α (alpha) and the curvature radius is in a range between 0.0001 and 1.

Preferably, the ball raceways have a cross section perpendicular to its course direction in the form of a parabola.

### BRIEF DESCRIPTION OF THE DRAWINGS

Further features and advantages of the invention will become apparent from the following description of an exemplary embodiment of the invention which is intended to be non-limiting, which in the following will be explained in more details by making reference to the figures, wherein:

FIG. 1 schematically shows an overall view of a ball sliding join according to the invention,

FIG. 2 schematically shows a joint inner part of a ball sliding joint according to the invention,

FIG. 3 shows an elevational view and a projection of neighboring ball raceways of a first and second group having angles of inclination α and β of a joint inner part,

FIG. 4a shows a sectional view along a bail raceway of a first group having radial distance r_{α},

FIG. 4b shows a sectional view along a ball raceway of a second group having radial distance r_{β},

FIG. 5 shows an elevational view of a joint inner part of a ball sliding joint according to the invention, especially showing the difference of the ball raceways with respect to the radial distance.

FIG. 6 shows an elevational view of three consecutive ball raceways, wherein the ball raceways outwardly situated in this figure have a linear course and the ball raceway located between these two (central ball raceway) has a curved course.

### DETAILED DESCRIPTION OF THE PRESENT INVENTION

In the various figures equal parts with respect to their function are throughout referred to by the same reference numbers so that the latter generally will only be described once.

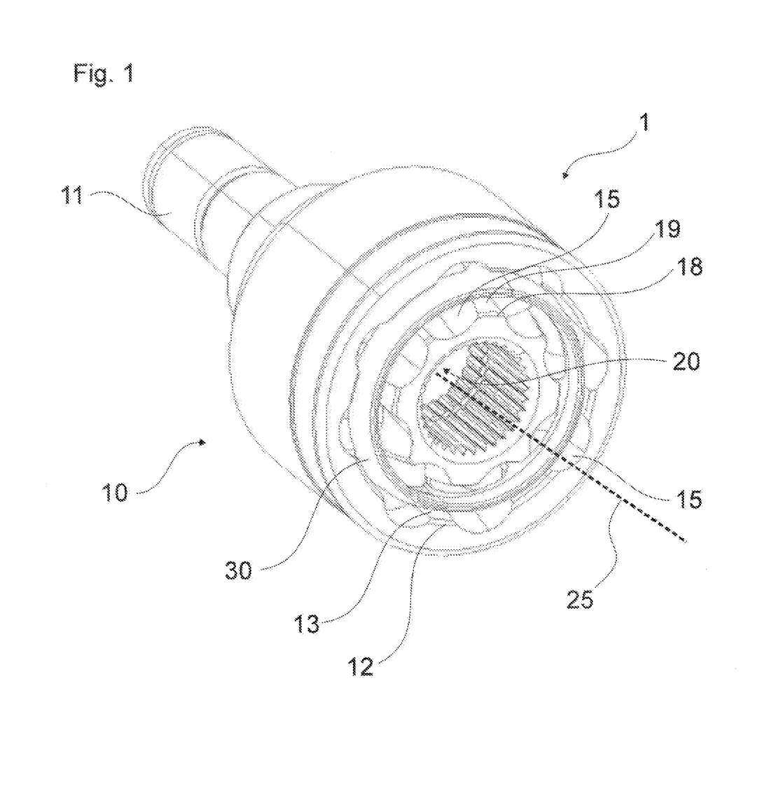

FIG. 1 shows an overall view of a ball sliding joint 1 according to the invention having inclined ball raceways 15. The sliding ball joint 1 comprises a joint outer part 10, a cage 30 containing balls, not shown herein, and a joint inner part 20, and it is arranged at an end of a pin 11.

The joint outer part 10 essentially is a circular hollow cylinder having an inner periphery 12, in the inner surface 13 thereof eight inclined ball raceways 15 are formed. The bail raceways 15 extend as grooves in the inner surface 13, along the longitudinal axis of the circular hollow cylinder, about an axis of rotation 25 of the joint outer part 10.

The joint inner part 20 is arranged within the joint outer part 10, and essentially is a circular hollow cylinder having an outer periphery 18, which defines an outer surface 19, in which eight inclined ball raceways 15 are formed. The ball raceways 15 extend as grooves in the outer surface 19, along the longitudinal axis of the circular hollow cylinder, about an axis of rotation 25 of the joint outer part 20. In the representation of the straight ball sliding joint 1 the axes of rotation 25 of the joint outer part 10 and the joint outer part 20 coincide.

The cage 30 is arranged between the joint outer part 10 and the joint inner part 20. The cage 30 is circularly formed, having eight windows, each one having arranged therein one ball.

The ball raceways 15 of the joint outer part 10 and the joint outer part 20 face each other in pairs, each one forming a ball raceway pair, into each one of which one ball is inserted.

The joint outer part 10 and the joint inner part 20 each comprise two groups of ball raceways 15 that are alternatingly arranged. A first group of ball raceways 15_{α} having an angle of inclination α and a second group of ball raceways 15_{β} having an angle of inclination β. The angles of inclination is the angle, with which a perpendicular projection of the ball raceway onto a plane, in which the axis of rotation is located (herein the drawing plane), intersects the axis of rotation.

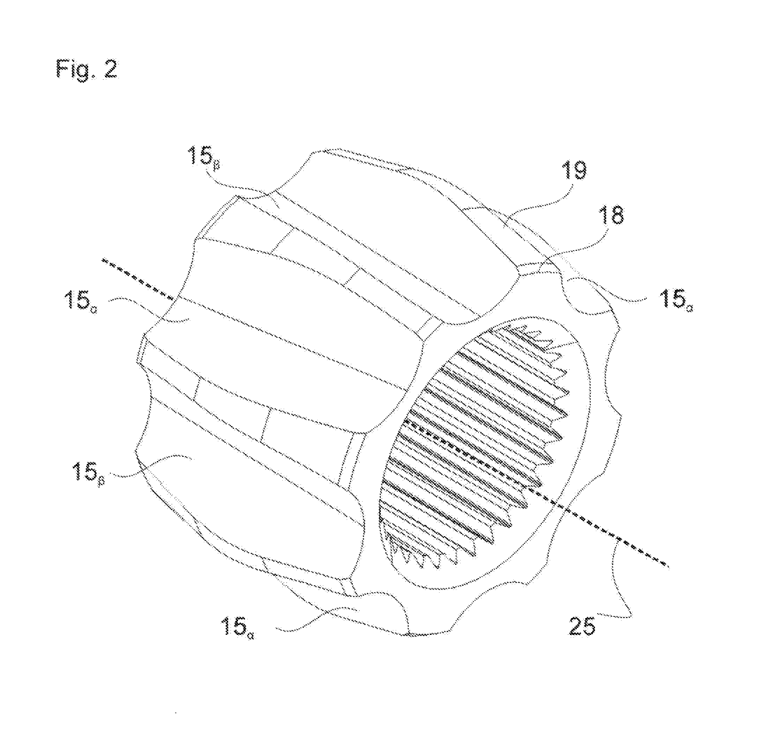

For clarification of the arrangement of the ball raceways 15_{α}, 15_{β}, in FIG. 2 a joint inner part 20 of a ball sliding joint 1 according to the invention is shown once again. As described above, the joint inner part 20 comprises eight ball raceways 15, wherein four ball raceways 15_{α} of a first group and four ball raceways 15_{β} of a second group alternate, respectively. The ball raceways 15_{α}, 15_{β} of the first and the second group differ from each other by their angle of inclination α and β, which they include with the axis of rotation 25. According to the invention, the following is true for the magnitudes of the angles of inclination: α<β, and 1>α/β>0.1.

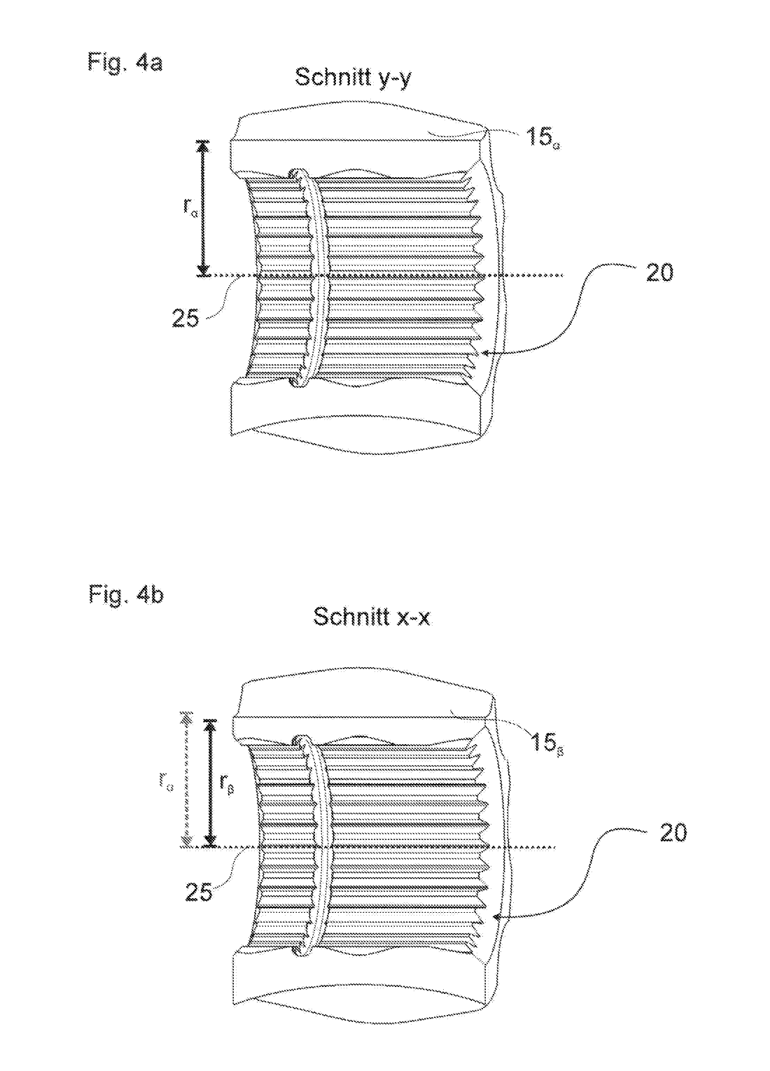

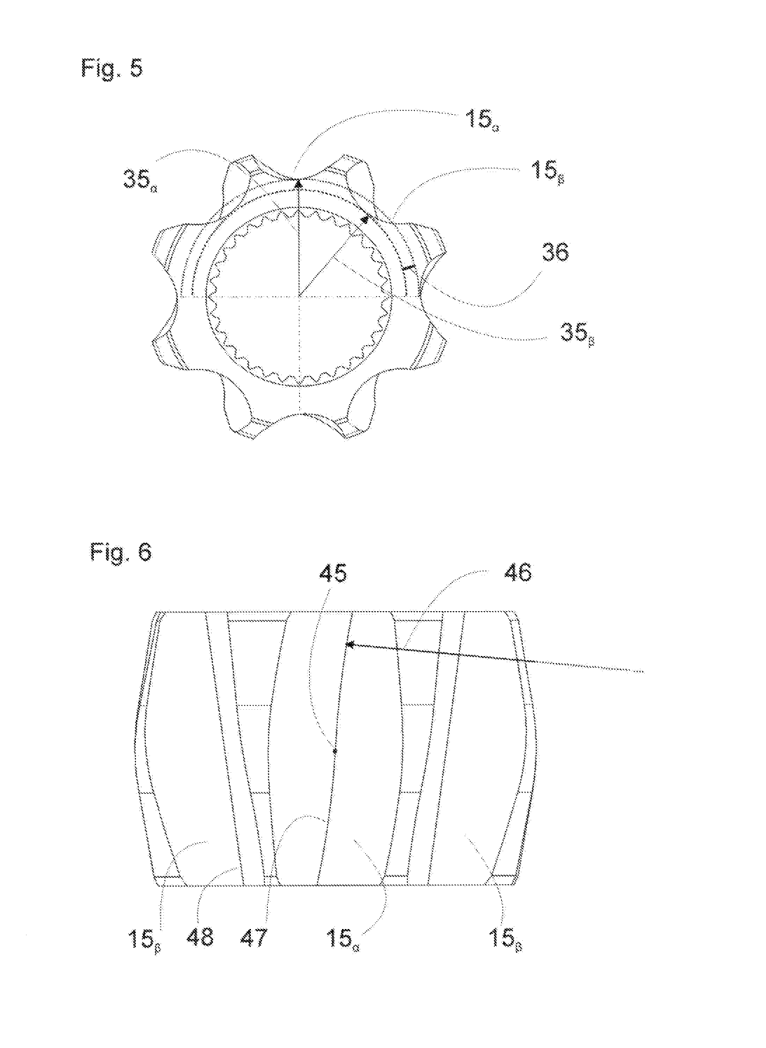

For further illustration of advantageous embodiments of the invention, especially of features of the ball raceways 15 the FIGS. 4-5 show projections and sectional views across ball raceways 15 of a (schematic) joint inner part 20. All features of the described ball raceways 15 equivalently relate to the respective ball raceways 15 of a joint outer part 10, which form raceway pairs with the described ball raceways 15 of the joint outer part 20 ball (see above).

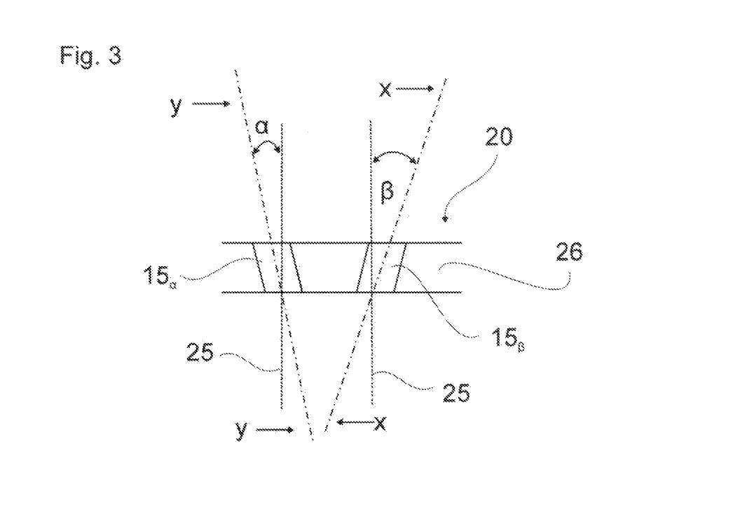

FIG. 3 shows an elevational view and a projection of neighboring ball raceways 15_{α} and 15_{β} of a joint inner part 20, respectively. The ball raceways 15_{α}, 15_{β} are projected onto a cylinder surface 26 about the axis of rotation 25. Also shown are projections of the respective axis of rotation 25 onto the cylinder surface 26. The two ball raceways 15_{α}, 15_{β} differ from each other with respect to the algebraic sign and the magnitude of the angle of inclination α and β with the projection of the respective axis of rotation 25. For clarification of the respective angles of inclination in FIG. 3 an axis y-y is drawn, extending along the ball raceways 15_{α} and including the angle of inclination α with the axis of rotation 25. Similarly, an axis x-x is drawn, extending along the ball raceways 15_{β} and including the angle of inclination β with the axis of rotation 25.

The FIGS. 4a and 4b each show sectional views along the axis y-y and along the axis x-x, respectively, to illustrate other possible embodiments of ball raceways 15.

FIG. 4a shows a sectional view along the axis y-y across a ball raceway 15_{α}, as can be seen in FIG. 3. FIG. 4b shows a sectional view along the axis x-x across a ball raceway 15_{β}, as can be seen in FIG. 3. The ball raceway 15_{α} belongs to a first group of ball raceways 15₆₀ , all of which including a matching angle of inclination having the magnitude α to the associated axis of rotation 25. The minimum radial distance of the ball raceways 15_{α} of the first group to the respective axis of rotation 25 is r_{α}. The ball raceway 15_{β} belongs to a second group of ball raceways 15_{β}, all of which including a matching angle of inclination having the magnitude β to the associated axis of rotation 25. The minimum radial distance of the ball raceways 15_{β} of the second group to the respective axis of rotation 25 is r_{β}. For the magnitudes of the angles of inclination the following is true: 1>α/β>0.075 and for the radial distances the following is true: r_{α}>r_{β}.

FIG. 5 shows a cross section of a preferred embodiment of a joint inner part of the ball sliding joint according to the invention, in which the minimum, first radial distance r_{α} of the first group 15_{α} is greater than der minimum second radial distance r_{β} of the second group 15_{β}. Thus, the following is true: r_{α}>r_{β}, wherein for the magnitudes of the angles of inclination the following is true: α<β and 1>α/β>0.075. The radial jump 36 shown in FIG. 5 of the minimum radial distance allows the joint volume to be more effectively utilized, moreover, due to the radial jump 36 a different introduction of the forces in the respective group 15_{α}, and 15_{β}, respectively, which may advantageously utilized in the designing the raceways. Consequently, ball raceways having lower angle of inclination become subjected to heavier loads. Due to the radial jump 36, with ball raceways of the group 15α it is possible to compensate the load caused by the lower bevel in that the radial distance of the associated ball raceways is increased, Thus, the sliding joint will globally become more resistant,

FIG. 6 shows a projection of three ball raceways, the two outer ball raceways comprising a straight course 48, the ball raceway located between the two outer ones (central ball raceway) having a curved, S-shaped course. The S-shaped course is characterized by a first order inflection point 45. The curved, S-shaped course 47 of the ball raceways is exclusively formed in the first group as having the angle of inclination α, whereas the straight course is exclusively formed in the second group. The S-shaped course is characterized in that at least one third of the overall course is defined by a constant curvature radius 46, wherein the ratio between the first angle of inclination α (alpha) and the curvature radius is in a range of between 0.0001 and 1. In FIG. 6 the curvature radius is schematically represented by an arrow, wherein the broken line part of the arrow is to indicate that the curvature radius is actually greater than shown.

### LIST OF REFERENCE

1 sliding ball joint
10 joint outer part
11 pin
12 inner periphery
13 inner surface
15 ball raceways
18 outer periphery
19 outer surface
20 joint inner part
25 axis of rotation
26 cylinder surface
30 cage
35 radial distance
36 radial jump
45 first order inflection point
46 curvature radius
47 all raceways having curved S-shaped course
48 ball raceways having straight course

Having described preferred embodiments of the invention, it will be apparent to those skilled in the art to which this invention relates, that modifications and amendments to various features and items can be effected and yet still come within the general concept of the invention. It is to be understood. that all such modifications and amendments are intended to be included within the scope of the present invention.

We claim:

1. A sliding ball joint, comprising:
a joint outer part having inclined ball raceways, which are formed on an inner periphery and which are arranged about an axis of rotation of the joint outer part, a joint inner part having inclined ball raceways, which are formed on an outer periphery and which are arranged about an axis of rotation of the joint inner part, wherein ball raceways of the joint outer part and of the joint inner part face each other in pairs and have angles of inclination opposite to each other, one ball per ball raceway pair, and a cage, which is arranged between the joint outer part and the joint inner part and having windows, in which the balls are accommodated, wherein the joint outer part and the joint inner part each have at least two groups of inclined ball raceways, the groups being different with respect to the magnitude of the angle of inclination to the respective axis of rotation, wherein a first group of ball raceways include an angle of inclination α (alpha) with the respective axis of rotation, and a second group of ball raceways include an angle of inclination β (beta) with the respective axis of rotation, wherein α<β (alpha less than beta) applies to the magnitudes and the ball raceways of the first group have an identical first, minimum radial distance from the respective axis of rotation and the ball raceways of the second group have an identical second, minimum radial distance from the respective axis of rotation and the first radial distance and second radial distance differ in magnitude.

2. The sliding ball joint according to claim 1, wherein furthermore for the magnitudes the following is true: 1>α/β>0.075, preferably the following is true: 1>α/β>0.1.

3. The sliding bail joint according to claim 1, wherein the first radial distance is greater than the second radial distance.

4. The sliding ball joint according to claim 1, wherein each of the ball raceways of the first and/or second group is arranged as being located about the respective axis of rotation in a tangential plane of a cylinder surface, and are preferably defined by a tangent to a cylinder surface about the respective axis of rotation.

5. The sliding ball joint according to claim 1, wherein the magnitude of the difference from the most minimum radial distance of the first group and the most minimum radial distance of the second group is between 0.01 mm and 10.00 mm.

6. The sliding ball joint according to claim 1, wherein the angle of inclination β (Beta) is selected such that it at least corresponds to half an angle of flexion, about which the joint outer part is jointly pivotable in relation to the joint inner part.

7. The sliding ball joint according to claim 1, wherein at least the number of the ball raceways of the first group is equal to the number of the ball raceways of the second group.

8. The sliding ball joint according to claim 1, wherein, in circumferential direction, the algebraic sign of the angle of inclination changes from ball raceway to ball raceway.

9. The sliding ball joint according to claim 1, wherein the ball raceways at least of one group have a linear course.

10. The sliding ball joint according to claim 9, wherein the ball raceways of the second group, exclusively, have a linear course.

11. The sliding ball joint according to claim 1, wherein the ball raceways at least of one group have a curved course having a first order inflection point 1.

12. The sliding ball joint according to claim 11, wherein the curved course is point-symmetric to the first order inflection point 1.

13. The sliding ball joint according to claim 12, wherein the curved course is defined by a constant curvature radius section by section across at least a quarter, of its overall course.

14. The sliding ball joint according to claim 13, wherein the ratio of the angle of inclination α (alpha) and the curvature radius is in a range between 0.0001 and 1.

15. The sliding ball joint according to claim 14, wherein the ball raceways have a cross section in the form of a parabola, perpendicular to their direction of course.

16. The sliding ball joint according to claim 1, wherein the number of the balls is three or more.

17. The sliding ball joint according to claim 5, wherein the magnitude of the difference from the most minimum radial distance of the first group and the most minimum radial distance of the second group is between 0.10 mm and 1.00 mm.

18. The sliding ball joint according to claim 13, wherein the curved course is defined by a constant curvature radius section by section across at least one third of its overall course.

19. The sliding ball joint according to claim 16, wherein the number of the balls is 6 or 8.
